(19) United States
(12) Patent Application Publication
(10) Pub. No.: US 2017/0098863 A1
(43) Pub. Date: Apr. 6, 2017

(54) METHOD OF MANUFACTURING NONAQUEOUS ELECTROLYTE SECONDARY BATTERY

(71) Applicant: TOYOTA JIDOSHA KABUSHIKI KAISHA, Toyota-shi (JP)

(72) Inventors: Kazuhisa TAKEDA, Toyota-shi (JP); Ryosuke OHSAWA, Okazaki-shi (JP)

(73) Assignee: TOYOTA JIDOSHA KABUSHIKI KAISHA, Toyota-shi (JP)

(21) Appl. No.: 15/283,719

(22) Filed: Oct. 3, 2016

(30) Foreign Application Priority Data
Oct. 5, 2015 (JP) 2015-197854

(51) Int. Cl. H01M 10/0585; H01M 10/0568; H01M 10/0525

(52) U.S. Cl. CPC H01M 10/0585; H01M 10/0525; H01M 10/0568

(57) ABSTRACT

A method of manufacturing a nonaqueous electrolyte secondary battery includes: accommodating an electrode body; accommodating a first nonaqueous electrolytic solution; and accommodating a second nonaqueous electrolytic solution. In the accommodation of the first nonaqueous electrolytic solution, the first nonaqueous electrolytic solution is accommodated in a battery case. In the accommodation of the second nonaqueous electrolytic solution, the second nonaqueous electrolytic solution is accommodated in the battery case that accommodates the electrode body and the first nonaqueous electrolytic solution. In the first nonaqueous electrolytic solution, LiPF₆ is dissolved as the electrolyte in the nonaqueous solvent without LiFSI, LiTFSI, and LiTFS being dissolved. In the second nonaqueous electrolytic solution, at least one selected from the group consisting of LiFSI, LiTFSI, and LiTFS is dissolved as the electrolyte in the nonaqueous solvent.

### INCORPORATION BY REFERENCE

The disclosure of Japanese Patent Application No. 2015-197854 filed on Oct. 5, 2015 including the specification, drawings and abstract is incorporated herein by reference in its entirety.

### BACKGROUND

1. Technical Field

The present disclosure relates to a method of manufacturing a nonaqueous electrolyte secondary battery. More specifically, the disclosure relates to a method of manufacturing a nonaqueous electrolyte secondary battery in which a current collector foil of a positive electrode sheet is made of aluminum.

2. Description of Related Art

In a lithium ion secondary battery, a positive electrode sheet and a negative electrode sheet are accommodated in a battery case together with an electrolytic solution. In the positive electrode sheet, a positive electrode active material layer including a positive electrode active material is formed on a surface of a positive electrode current collector foil. In the negative electrode sheet, a negative electrode active material layer including a negative electrode active material is formed on a surface of a negative electrode current collector foil. In general, an aluminum foil is used as the positive electrode current collector foil, and a copper foil is used as the negative electrode current collector foil. In the nonaqueous electrolytic solution, a lithium salt as an electrolyte is dissolved in a nonaqueous solvent. In general, lithium hexafluorophosphate represented by the formula LiPF₆ is used as the electrolyte.

However, recently, lithium bis(fluorosulfonyl)imide (LiFSI) represented by the formula LiN(SO₂F)₂ has been also used as an electrolyte of a nonaqueous electrolytic solution. The reason for this is that, by using LiFSI as the electrolyte, the ionic conductance of the nonaqueous electrolytic solution can be improved. For example, in the related art, Japanese Patent Application Publication No. 2012-182130 (JP 2012-182130 A) discloses a technique of using a nonaqueous electrolytic solution in which LiFSI is dissolved.

### SUMMARY

However, in a lithium ion secondary battery in which a nonaqueous electrolytic solution including LiFSI is used, there is a problem in that aluminum for forming a positive electrode current collector foil is eluted into the nonaqueous electrolytic solution. Further, there is a problem in that aluminum eluted into the nonaqueous electrolytic solution is deposited on a surface of a negative electrode sheet.

The present disclosure provides a method of manufacturing a nonaqueous electrolyte secondary battery in which elution of aluminum from a positive electrode current collector foil can be prevented.

According to a first aspect of the disclosure, there is provided a method of manufacturing a nonaqueous electrolyte secondary battery, the nonaqueous electrolyte secondary battery including a positive electrode sheet, a negative electrode sheet, a nonaqueous electrolytic solution that is obtained by dissolving an electrolyte in a nonaqueous solvent, and a battery case that accommodates the positive electrode sheet, the negative electrode sheet, and the nonaqueous electrolytic solution, the positive electrode sheet including a positive electrode current collector foil and a positive electrode active material layer that is formed on the positive electrode current collector foil, and the positive electrode current collector foil having a surface on which a positive electrode non-contact portion which does not contact the positive electrode active material layer is formed. The method according to the first aspect of the disclosure includes: accommodating an electrode body including the positive electrode sheet and the negative electrode sheet in the battery case, the positive electrode sheet having a configuration in which the positive electrode current collector foil is made of aluminum; accommodating a first nonaqueous electrolytic solution in the battery case, the first nonaqueous electrolytic solution having a configuration in which lithium hexafluorophosphate is dissolved as the electrolyte in the nonaqueous solvent without lithium bis(fluorosulfonyl)imide, lithium bis(trifluoromethanesulfonyl)imide, and lithium trifluoromethanesulfonate being dissolved; and accommodating a second nonaqueous electrolytic solution in the battery case that accommodates the electrode body and the first nonaqueous electrolytic solution, the second nonaqueous electrolytic solution having a configuration in which at least one selected from the group consisting of lithium bis(fluorosulfonyl)imide, lithium bis(trifluoromethanesulfonyl)imide, and lithium trifluoromethanesulfonate is dissolved as the electrolyte in the nonaqueous solvent.

According to the first aspect of the disclosure, first, the first nonaqueous electrolytic solution in which lithium hexafluorophosphate is dissolved as the electrolyte can be made to contact the electrode body. As a result, a passive film can be formed on a surface of the positive electrode current collector foil in the positive electrode non-contact portion of the positive electrode sheet, the passive film being derived from aluminum of the positive electrode current collector foil and lithium hexafluorophosphate as the electrolyte of the first nonaqueous electrolytic solution. Accordingly, the elution of aluminum from the positive electrode current collector foil in the positive electrode non-contact portion of the positive electrode sheet can be prevented even when the second nonaqueous electrolytic solution, in which lithium bis(fluorosulfonyl)imide, lithium bis(trifluoromethanesulfonyl)imide, or lithium trifluoromethanesulfonate is dissolved as the electrolyte, is accommodated in the battery case.

In the method according to the first aspect, the second nonaqueous electrolytic solution may be accommodated in the battery case 20 minutes or longer after accommodating the electrode body and the first nonaqueous electrolytic solution in the battery case. The reason for this is that the second nonaqueous electrolytic solution can be accommodated in the battery case after the passive film is sufficiently formed on the surface of the positive electrode current collector foil in the positive electrode non-contact portion of the positive electrode sheet. This sufficiently formed passive film can reliably prevent the elution of aluminum from the positive electrode current collector foil which is caused by the nonaqueous electrolytic solution in which lithium bis(fluorosulfonyl)imide, lithium bis(trifluoromethanesulfonyl)imide, or lithium trifluoromethanesulfonate is dissolved.

The method according to the first aspect may further include: reducing an internal pressure of the battery case to be lower than atmospheric pressure after accommodating the electrode body and the first nonaqueous electrolytic solution in the battery case; and increasing the reduced internal pressure of the battery case before accommodating the second nonaqueous electrolytic solution in the battery case. As a result, the time required for the electrode body to absorb the first nonaqueous electrolytic solution can be reduced.

The method according to the first aspect may further include: reducing an internal pressure of the battery case to be lower than atmospheric pressure after accommodating the second nonaqueous electrolytic solution in the battery case; and increasing the reduced internal pressure of the battery case. As a result, the time required for the electrode body to absorb the second nonaqueous electrolytic solution can be reduced.

According to the disclosure, a method of manufacturing a nonaqueous electrolyte secondary battery can be provided in which elution of aluminum from a positive electrode current collector foil can be prevented.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a sectional view showing a battery according to an embodiment;

FIG. 2 is a sectional view showing a positive electrode sheet and the like used in the battery according to the embodiment;

FIG. 3 is a diagram showing the procedure of an accommodation step according to a first embodiment;

FIG. 4 is a diagram showing the procedure of an accommodation step according to a second embodiment; and

FIG. 5 is a graph showing an internal pressure of a battery case in the accommodation step according to the second embodiment.

### DETAILED DESCRIPTION OF EMBODIMENTS

Hereinafter, a preferred embodiment of the disclosure will be described in detail with reference to the drawings.

### First Embodiment

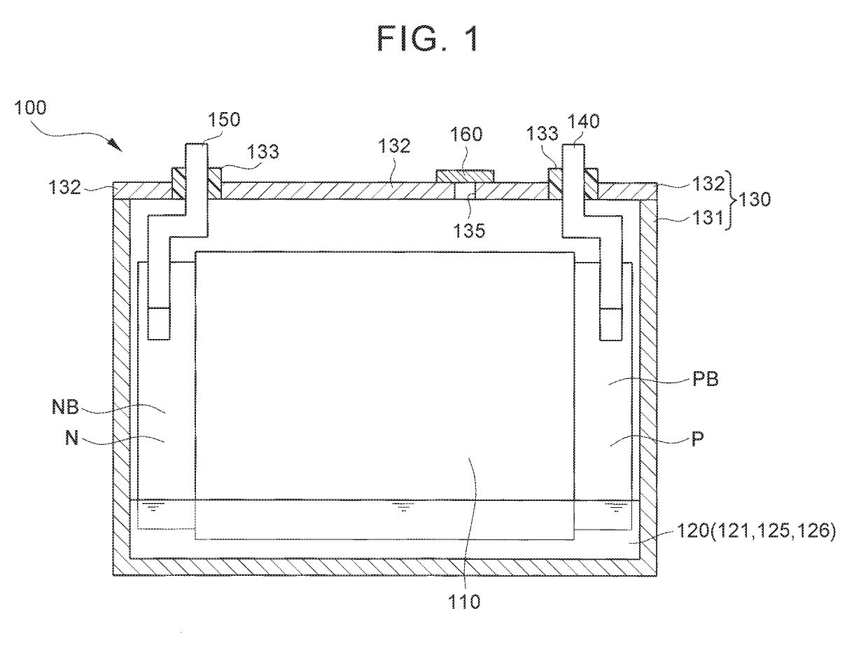

First, a battery 100 (refer to FIG. 1) according to a first embodiment will be described. FIG. 1 shows a sectional view showing the battery 100 according to the first embodiment. As shown in FIG. 1, the battery 100 is a lithium ion secondary battery in which an electrode body 110 and an electrolytic solution 120 are accommodated in a battery case 130.

The battery case 130 includes a case body 131 and a sealing plate 132. The sealing plate 132 includes an insulating member 133. A liquid injection hole 135 is formed on the sealing plate 132. As shown in FIG. 1, the liquid injection hole 135 is sealed with a liquid injection stopper 160.

The electrolytic solution 120 according to the first embodiment is a nonaqueous electrolytic solution in which two electrolytes including a first electrolyte 125 and a second electrolyte 126 are dissolved in a nonaqueous solvent 121. Specifically, in the electrolytic solution 120 according to the first embodiment, as the nonaqueous solvent 121, a mixed organic solvent is used in which ethylene carbonate (EC), dimethyl carbonate (DMC), and ethyl methyl carbonate (EMC) which are organic solvents are mixed with each other. As the nonaqueous solvent 121, one of the above-described organic solvents can also be used alone. Alternatively, another organic solvent may also be used as the nonaqueous solvent 121.

In the electrolytic solution 120 according to the first embodiment, lithium hexafluorophosphate represented by the formula LiPF₆ is dissolved as the first electrolyte 125. Further, in the electrolytic solution 120 according to the first embodiment, lithium bis(fluorosulfonyl)imide (LiFSI) represented by the formula LiN(SO₂F)₂ is dissolved as the second electrolyte 126.

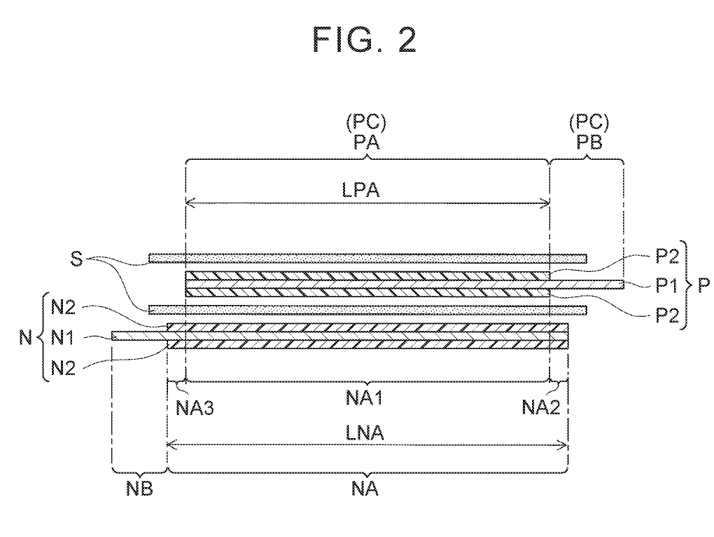

FIG. 2 is a sectional view showing a positive electrode sheet P, a negative electrode sheet N, and separators S that constitute the electrode body 110. All of the positive electrode sheet P, the negative electrode sheet N, and the separators S have an elongated sheet shape in a depth direction of FIG. 2. The electrode body 110 is a flat wound body obtained by laminating the positive electrode sheet P, the negative electrode sheet N, and the two separators S as shown in FIG. 2 and winding the obtained laminate such that a width direction, which is a left-right direction in FIG. 2, is a winding axial direction.

As shown in FIG. 2, in the positive electrode sheet P, a positive electrode active material layer P2 is formed on both surfaces of a positive electrode current collector foil P1. As shown in FIG. 2, the positive electrode sheet P has two regions including: a positive electrode-forming region PA in which the positive electrode active material layer P2 is formed on the positive electrode current collector foil P1; and a positive electrode non-forming region PB that is formed of a portion of the positive electrode current collector foil P1 on which the positive electrode active material layer P2 is not formed. That is, as indicated by a parenthesis in FIG. 2, the positive electrode non-forming region PB is a positive electrode non-contact portion PC that is formed on a surface of the positive electrode current collector foil P1 and does not contact the positive electrode active material layer P2.

As shown in FIG. 2, the positive electrode-forming region PA is formed along a left end of the positive electrode current collector foil P1 in a longitudinal direction of the positive electrode current collector foil P1, and the positive electrode non-forming region PB is formed along a right end of the positive electrode current collector foil P1 in the longitudinal direction of the positive electrode current collector foil P1. FIG. 2 shows a length LPA of the positive electrode-forming region PA in the width direction.

As the positive electrode current collector foil P1, an aluminum foil can be used. The positive electrode active material layer P2 includes at least a positive electrode active material. In addition to the positive electrode active material, the positive electrode active material layer P2 according to the first embodiment further includes a conductive additive and a binder.

The positive electrode active material is a component contributing to the charging and discharging of the battery 100 and can store and release lithium ions. As the positive electrode active material, for example, LiNiCoMnO₂ (NCM) can be used. The conductive additive can improve the conductivity of the positive electrode active material layer P2. As the conductive additive, for example, acetylene black (AB) can be used. The binder binds the materials, which are included in the positive electrode active material layer P2, to each other to form the positive electrode active material layer P2, and can also bind the positive electrode active material layer P2 to a surface of the positive electrode current collector foil P1. As the binder, for example, polyvinylidene fluoride (PVDF) can be used.

As shown in FIG. 2, in the negative electrode sheet N, a negative electrode active material layer N2 is formed on both surfaces of a negative electrode current collector foil N1. As shown in FIG. 2, the negative electrode sheet N has two regions including: a negative electrode-forming region NA in which the negative electrode active material layer N2 is formed on the negative electrode current collector foil N1; and a negative electrode non-forming region NB that is formed of a portion of the negative electrode current collector foil N1 on which the negative electrode active material layer N2 is not formed. As shown in FIG. 2, the negative electrode-forming region NA is formed along a right end of the negative electrode current collector foil N1 in a longitudinal direction of the negative electrode current collector foil N1, and the negative electrode non-forming region NB is formed along a left end of the negative electrode current collector foil N1 in the longitudinal direction of the negative electrode current collector foil N1. FIG. 2 shows a length LNA of the negative electrode-forming region NA in the width direction.

As shown in FIG. 2, the length LNA of the negative electrode-forming region NA is longer than the length LPA of the positive electrode-forming region PA. Therefore, in the electrode body 110, the negative electrode-forming region NA includes three portions including: a forming-region facing portion NA1 that faces positive electrode-forming region PA; a non-forming region facing portion NA2 that faces the positive electrode non-forming region PB; and a non-facing portion NA3 that does not face the positive electrode sheet P.

As the negative electrode current collector foil N1, a copper foil can be used. The negative electrode active material layer N2 includes at least a negative electrode active material. In addition to the negative electrode active material, the negative electrode active material layer N2 according to the first embodiment further includes a binder and a thickener.

The negative electrode active material is a component contributing to the charging and discharging of the battery 100 and can store and release lithium ions. As the negative electrode active material, for example, graphite can be used. The binder binds the materials, which are included in the negative electrode active material layer N2, to each other to form the negative electrode active material layer N2, and can also bind the negative electrode active material layer N2 to a surface of the negative electrode current collector foil N1. As the binder, for example, styrene-butadiene rubber (SBR) can be used. The thickener can adjust the viscosity of a negative electrode paste described below. For example, as the thickener, carboxymethyl cellulose (CMC) can be used.

The separator S is a porous member and has plural pores. The separator S can insulate the positive electrode sheet P and the negative electrode sheet N from each other. The separator S can hold the electrolytic solution 120 in the pores. As the separator S, for example, polypropylene (PP) or polyethylene (PE) can be used alone, or a composite material in which plural materials among the above materials are laminated can be used.

In the wound electrode body 110 shown in FIG. 1, a right end portion consists of only the positive electrode non-forming region PB. In the wound electrode body 110 shown in FIG. 1, a left end portion consists of only the negative electrode non-forming region NB of the negative electrode sheet N. As shown in FIG. 1, a positive electrode terminal 140 is connected to the right end portion of the electrode body 110 consisting of only the positive electrode non-forming region PB. A negative electrode terminal 150 is connected to the left end portion of the electrode body 110 consisting of only the negative electrode non-forming region NB. Respective ends of the positive electrode terminal 140 and the negative electrode terminal 150 which are not connected to the electrode body 110 protrude to the outside of the battery case 130 through the insulating member 133.

On the other hand, at the center of the electrode body 110 in FIG. 1, as shown in FIG. 2, the positive electrode-forming region PA of the positive electrode sheet P and the negative electrode-forming region NA of the negative electrode sheet N are laminated and wound with the separators S interposed therebetween in a state where the positive electrode-forming region PA and the negative electrode-forming region NA face each other. The battery 100 is charged and discharged at the center of the electrode body 110 through the positive electrode terminal 140 and the negative electrode terminal 150.

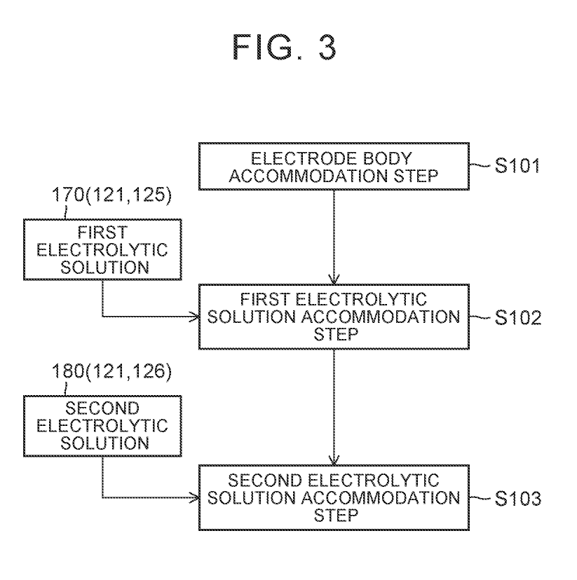

Next, a method of manufacturing the battery 100 according to the embodiment will be described. In the method of manufacturing the battery 100 according to the first embodiment, an accommodation step shown in FIG. 3 is performed.

That is, in the accommodation step according to the first embodiment, as shown in FIG. 3, first, an electrode body accommodation step (S101) is performed. In the electrode body accommodation step, the electrode body 110 is accommodated in the case body 131 through an opening. The electrode body 110 may be manufactured before the accommodation step. Specifically, the electrode body according to the first embodiment can be manufactured by winding the positive electrode sheet P, the negative electrode sheet N, and the two separators S in a flat shape. Alternatively, the flat electrode body 110 can be manufactured by winding the positive electrode sheet P, the negative electrode sheet N, and the two separators S in a cylindrical shape and pressing the wound body in the radial direction. The lamination and winding of the positive electrode sheet P, the negative electrode sheet N, and the separators S for manufacturing the electrode body 110 will be described in more detail using FIG. 2.

In the electrode body accommodation step according to the first embodiment, after accommodating the electrode body 110 in the case body 131, the opening of the case body 131 is sealed with the sealing plate 132, and the case body 131 and the sealing plate 132 are joined to each other. The positive electrode terminal 140 and the negative electrode terminal 150 may be connected to the electrode body 110 before accommodating the electrode body 110 in the case body 131. The joining of the battery case 130 or the joining of the positive and negative electrode terminals 140, 150 and the electrode body 110 can be performed by welding or the like.

In the embodiment, as shown in FIG. 3, a first electrolytic solution accommodation step (S102) is performed after the electrode body accommodation step (S101). In the first electrolytic solution accommodation step, a first electrolytic solution 170 is injected into the battery case 130 through the liquid injection hole 135 of the sealing plate 132. As a result, the first electrolytic solution 170 is accommodated in the battery case 130. In the first electrolytic solution 170 which is accommodated in the battery case 130 in the first electrolytic solution accommodation step, LiPF₆ as the first electrolyte 125 is dissolved in the nonaqueous solvent 121. That is, in the first electrolytic solution 170, LiFSI as the second electrolyte 126 is not dissolved.

In the first embodiment, as shown in FIG. 3, a second electrolytic solution accommodation step (S103) is performed after the first electrolytic solution accommodation step (S102). In the second electrolytic solution accommodation step, a second electrolytic solution 180 is injected into the battery case 130 through the liquid injection hole 135 of the sealing plate 132. As a result, the second electrolytic solution 180 is accommodated in the battery case 130. The second electrolytic solution 180 is different from the first electrolytic solution 170. In the second electrolytic solution 180 which is accommodated in the battery case 130 in the second electrolytic solution accommodation step, LiFSI as the second electrolyte 126 is dissolved in the nonaqueous solvent 121. In the second electrolytic solution 180 according to the first embodiment, LiPF₆ as the first electrolyte 125 is not dissolved.

After the second electrolytic solution accommodation step, the liquid injection hole 135 of the battery case 130 is sealed with the liquid injection stopper 160. That is, the liquid injection hole 135 is sealed with the liquid injection stopper 160, and the liquid injection stopper 160 is fixed to the sealing plate 132. The fixing of the liquid injection stopper 160 to the sealing plate 132 can be performed by, for example, welding.

Regarding the battery 100 which has undergone the accommodation step, appropriately, initial charging or an aging treatment is performed. In order to remove a defective product in the manufacturing steps, appropriately, an inspection step or the like may be performed. As a result, the battery 100 can be manufactured.

Here, in the first electrolytic solution accommodation step of the accommodation step according to the first embodiment, the first electrolytic solution 170 is used in which LiPF₆ as the first electrolyte 125 is dissolved in the nonaqueous solvent 121 without LiFSI as the second electrolyte 126 being dissolved. Therefore, in the first electrolytic solution accommodation step, the first electrolytic solution 170 accommodated in the battery case 130 contacts the electrode body 110. That is, the first electrolytic solution 170 contacts the positive electrode sheet P and the negative electrode sheet N.

By the first electrolytic solution 170 contacting the positive electrode non-forming region PB (exposure portion of the positive electrode current collector foil P1) which is the positive electrode non-contact portion PC of the positive electrode sheet P, a passive film is formed on a surface of the positive electrode non-forming region PB. This passive film is formed of aluminum fluoride (AlF₃) derived from aluminum, which is the material of the positive electrode current collector foil P1, and LiPF₆ as the first electrolyte 125 of the first electrolytic solution 170.

In the second electrolytic solution accommodation step performed after the first electrolytic solution accommodation step, the second electrolytic solution 180 is used in which LiFSI as the second electrolyte 126 is dissolved in the nonaqueous solvent 121. In the second electrolytic solution accommodation step, the second electrolytic solution 180 accommodated in the battery case 130 contacts the electrode body 110 while being mixed with the first electrolytic solution 170 accommodated in the battery case 130 before the accommodation of the second electrolytic solution 180. That is, a mixture of the first electrolytic solution 170 and the second electrolytic solution 180 is the electrolytic solution 120 in which LiPF₆ as the first electrolyte 125 and LiFSI as the second electrolyte 126 are dissolved in the nonaqueous solvent 121. The electrolytic solution 120 obtained by mixing the first electrolytic solution 170 and the second electrolytic solution 180 with each other contacts the positive electrode sheet P and the negative electrode sheet N.

That is, in the first embodiment, the electrode body accommodation step and the first electrolytic solution accommodation step are performed before the second electrolytic solution accommodation step. As a result, the positive electrode non-forming region PB as the positive electrode non-contact portion PC can be made to contact the first electrolytic solution 170 in which LiPF₆ as the first electrolyte 125 is dissolved. Therefore, in the first embodiment, a passive film can be formed on the positive electrode non-forming region PB as the positive electrode non-contact portion PC before the second electrolytic solution 180 or the electrolytic solution 120 in which LiFSI as the second electrolyte 126 is dissolved contacts the positive electrode non-forming region PB.

Accordingly, the positive electrode non-forming region PB on which the passive film is formed is not corroded even if contacting the electrolytic solution 120 in which LiFSI is dissolved. Accordingly, in the first embodiment, aluminum constituting the positive electrode current collector foil P1 in the positive electrode non-contact portion PC is prevented from being eluted into the electrolytic solution 120. Accordingly, in the battery 100 according to the first embodiment, aluminum eluted from the positive electrode current collector foil P1 is prevented from being deposited on the negative electrode sheet N.

In the electrode body 110, in a case where aluminum is eluted from the positive electrode current collector foil P1 in the positive electrode non-contact portion PC, the eluted aluminum is likely to be deposited on a portion of the negative electrode-forming region NA of the negative electrode sheet N where a current flows during charging and which is close to the positive electrode non-contact portion PC. Specifically, in the negative electrode sheet N, aluminum is more likely to be deposited, in particular, at a position of the forming-region facing portion NA1 close to the non-forming region facing portion NA2. The reason for this is that the position of the forming-region facing portion is at a short distance from the positive electrode non-forming region PB as the positive electrode non-contact portion PC where a current flows during charging.

When aluminum is deposited on a portion of the negative electrode sheet N, the resistance value of the portion increases. Therefore, lithium is likely to be deposited on the portion of the negative electrode sheet N where the resistance value increases. Accordingly, in a case where aluminum is eluted from the positive electrode current collector foil P1, a large amount of lithium may be deposited on the negative electrode sheet N within a short period of time. However, in the first embodiment, the elution of aluminum in the positive electrode non-contact portion PC is prevented by the passive film. Thus, the deposition of a large amount of lithium on the negative electrode sheet N within a short period of time is prevented.

The battery 100 according to the first embodiment includes the electrolytic solution 120 in which LiFSI as the second electrolyte 126 is dissolved. Thus, the ionic conductance is improved compared to a battery including an electrolytic solution in which only LiPF₆ as the first electrolyte 125 is dissolved. Accordingly, in the battery 100 according to the first embodiment, an increase in internal resistance caused when high-rate charging and discharging is repeated is prevented.

That is, in a case where the ionic conductance of the electrolytic solution 120 is low, the deviation of a lithium salt concentration increases during high-rate charging and discharging, and thus the internal resistance increases. However, in the battery 100 according to the first embodiment, the ionic conductance of the electrolytic solution 120 is high. Therefore, during high-rate charging and discharging, the deviation of the lithium salt concentration decreases. Accordingly, in the battery 100 according to the first embodiment, the internal resistance can be maintained to be low during high-rate charging and discharging. That is, the durability of the battery according to the first embodiment is high.

### Second Embodiment

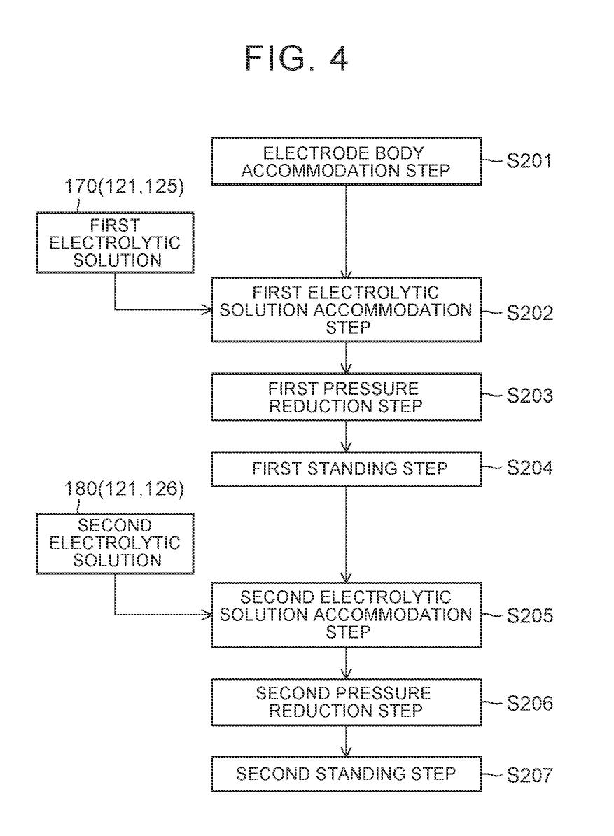

Next, a second embodiment will be described. A battery manufactured according to the second embodiment is the same as the battery 100 according to the first embodiment. In the second embodiment, the battery 100 is manufactured through an accommodation step different from that of the first embodiment. FIG. 4 shows an accommodation step in the method of manufacturing the battery 100 according to the second embodiment.

In the accommodation step according to the second embodiment, as shown in FIG. 4, first, an electrode body accommodation step (S201) is performed. In the electrode body accommodation step, as in the case of the first embodiment, the electrode body 110 is accommodated in the case body 131 through an opening. In the electrode body accommodation step according to the second embodiment, after accommodating the electrode body 110 in the case body 131, the opening of the case body 131 is sealed with the sealing plate 132, and the case body 131 and the sealing plate 132 are joined to each other.

Next, in the second embodiment, a first electrolytic solution accommodation step (S202) is performed after the electrode body accommodation step (S201). In the first electrolytic solution accommodation step according to the second embodiment, as in the case of the first embodiment, the first electrolytic solution 170 is injected into the battery case 130 through the liquid injection hole 135 of the sealing plate 132. As a result, the first electrolytic solution 170 is accommodated in the battery case 130. In the second embodiment, in the first electrolytic solution 170, as in the case of the first embodiment, LiPF₆ as the first electrolyte 125 is dissolved in the nonaqueous solvent 121.

In the second embodiment, unlike the first embodiment, as shown in FIG. 4, a first pressure reduction step (S203) is performed after the first electrolytic solution accommodation step (S202). In the first pressure reduction step, the internal pressure of the battery case 130 is reduced to be lower than atmospheric pressure. Therefore, the battery case 130 in which the liquid injection hole 135 is opened without being sealed is accommodated in a vacuum chamber. Further, the internal pressure of the vacuum chamber is reduced by vacuuming the vacuum chamber that accommodates the battery case 130.

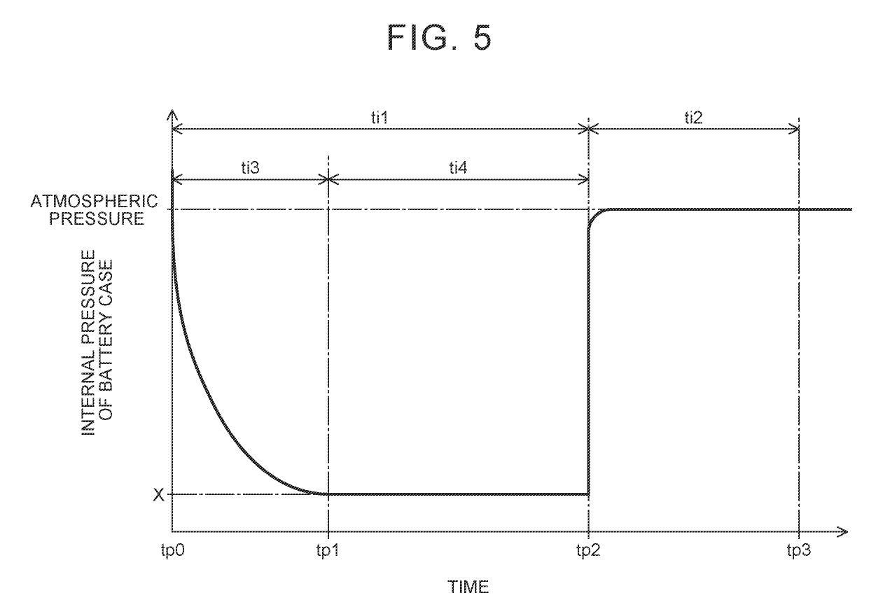

FIG. 5 is a graph showing an internal pressure of the battery case 130 in the accommodation step according to the second embodiment. A time tp0 in FIG. 5 represents the time at which the vacuum chamber accommodating the battery case 130 is vacuumed in the first pressure reduction step. In FIG. 5, the first pressure reduction step is performed during a period ti1 from the time tp0 to a time tp2.

In the first pressure reduction step according to the second embodiment, as shown in FIG. 5, the internal pressure of the battery case 130 is reduced from atmospheric pressure to a pressure X during a period ti3 from the time tp0 to a time tp1. Further, In the first pressure reduction step, the internal pressure of the battery case 130 is maintained at the pressure X during a period ti4 from the time tp1 to the time tp2.

The pressure X may be set as, for example, 10 kPa. The period ti1 during which the first pressure reduction step is performed may be set as, for example, 15 seconds to 60 seconds. The period ti3 during which the internal pressure of the battery case 130 is reduced may be set as, for example, 6 seconds. Therefore, the period ti4 during which the reduced internal pressure of the battery case 130 is maintained may be set as, for example, 9 to 54 seconds. In the second embodiment, the first pressure reduction step is performed by accommodating the battery case 130, in which the liquid injection hole 135 is opened, in the vacuum chamber during the period ti1.

In the second embodiment, as shown in FIG. 4, a first standing step (S204) is performed after the first pressure reduction step (S203). In the first standing step, the battery case 130 is left to stand for a predetermined period of time such that the electrode body 110 absorbs the first electrolytic solution 170 accommodated in the battery case 130. In the second embodiment, the first standing step is performed after increasing the internal pressure of the battery case 130 to be higher than that in the first pressure reduction step. Specifically, the first standing step is performed after increasing the internal pressure of the battery case 130 to be the same as atmospheric pressure. Therefore, the battery case 130 accommodated in the vacuum chamber is extracted from the vacuum chamber. In the battery case 130 extracted from the vacuum chamber, the liquid injection hole 135 is opened.

In the graph shown in FIG. 5, the time tp2 is the time at which the battery case 130 is extracted from the vacuum chamber. As shown in FIG. 5, the internal pressure of the battery case 130 increases to atmospheric pressure after the time tp2 at which the battery case 130 is extracted from the vacuum chamber. The reason for this is that the liquid injection hole 135 is opened. In the first standing step, the battery case 130 is left to stand during the period ti2 from the time tp2 to a time tp3 while maintaining the internal pressure of the battery case 130 at the same pressure as atmospheric pressure. In the second embodiment, the period ti2 of the first standing step is set as 20 minutes.

In the second embodiment, as shown in FIG. 4, a second electrolytic solution accommodation step (S205) is performed after the first standing step (S204). In the second electrolytic solution accommodation step according to the second embodiment, as in the case of the first embodiment, the second electrolytic solution 180 is injected into the battery case 130 through the liquid injection hole 135 of the sealing plate 132. As a result, the second electrolytic solution 180 is accommodated in the battery case 130. In the second embodiment, in the second electrolytic solution 180, LiFSI as the second electrolyte 126 is dissolved in the nonaqueous solvent 121, and the second electrolytic solution 180 is different from the first electrolytic solution 170.

In the second embodiment, as shown in FIG. 4, a second pressure reduction step (S206) is performed after the second electrolytic solution accommodation step (S205). In the second pressure reduction step, as in the case of the first pressure reduction step, the internal pressure of the battery case 130 is reduced to be lower than atmospheric pressure. Therefore, in the second pressure reduction step, the battery case 130 in which the liquid injection hole 135 is opened is accommodated in a vacuum chamber, and the vacuum chamber is vacuumed. The second pressure reduction step is performed by accommodating the battery case 130, in which the liquid injection hole 135 is opened, in the vacuum chamber for a predetermined period of time. Conditions of the second pressure reduction step such as a period during which the second pressure reduction step is performed or a reduced internal pressure of the battery case 130 may be set to be the same as those of the first pressure reduction step.

In the second embodiment, as shown in FIG. 4, a second standing step (S207) is performed after the second pressure reduction step (S206). In the second standing step, as in the case of the first standing step, the battery case 130 in which the liquid injection hole 135 is opened is extracted from the vacuum chamber. Further, the second standing step is performed by leaving the battery case 130, in which the liquid injection hole 135 is opened, to stand for a predetermined period of time while maintaining the internal pressure of the battery case 130 at the same pressure as atmospheric pressure. The period during which the second standing step is performed can be set to be the same as that of the first standing step. In the second standing step, the electrode body 110 can absorb the second electrolytic solution 180 accommodated in the battery case 130.

After the second standing step, the liquid injection hole 135 of the battery case 130 is sealed with the liquid injection stopper 160. That is, the liquid injection hole 135 is sealed with the liquid injection stopper 160, and the liquid injection stopper 160 is fixed to the sealing plate 132. The fixing of the liquid injection stopper 160 to the sealing plate 132 can be performed by, for example, welding.

In the second embodiment, as in the case of the first embodiment, regarding the battery 100 which has undergone the accommodation step, appropriately, initial charging or an aging treatment is performed. In order to remove a defective product in the manufacturing steps, appropriately, an inspection step or the like may be performed. As a result, the battery 100 can be manufactured.

In the second embodiment, the electrode body accommodation step and the first electrolytic solution accommodation step are performed before the second electrolytic solution accommodation step. As a result, the positive electrode non-forming region PB as the positive electrode non-contact portion PC can be made to contact the first electrolytic solution 170 in which LiPF₆ as the first electrolyte 125 is dissolved. Therefore, in the second embodiment, a passive film can be formed on the positive electrode non-forming region PB as the positive electrode non-contact portion PC before the second electrolytic solution 180 or the electrolytic solution 120 in which LiFSI as the second electrolyte 126 is dissolved contacts the positive electrode non-forming region PB.

Accordingly, in the second embodiment, aluminum constituting the positive electrode current collector foil P1 in the positive electrode non-contact portion PC is prevented from being eluted into the electrolytic solution 120. Accordingly, in the battery 100 according to the second embodiment, aluminum eluted from the positive electrode current collector foil P1 is prevented from being deposited on the negative electrode sheet N. However, in the second embodiment, the elution of aluminum in the positive electrode non-contact portion PC is prevented by the passive film. Thus, the deposition of a large amount of lithium on the negative electrode sheet N within a short period of time is prevented.

The battery 100 according to the second embodiment includes the electrolytic solution 120 in which LiFSI as the second electrolyte 126 is dissolved. Thus, the ionic conductance is improved compared to a battery including an electrolytic solution in which only LiPF₆ as the first electrolyte 125 is dissolved. Accordingly, in the battery 100 according to the second embodiment, an increase in internal resistance caused when high-rate charging and discharging is repeated is reduced.

In the second embodiment, before the second electrolytic solution accommodation step, the first standing step is performed such that the electrode body 110, which is accommodated in the battery case 130 in the electrode body accommodation step, absorbs the first electrolytic solution 170 which is accommodated in the battery case 130 in the first electrolytic solution accommodation step. In the second embodiment, the period ti2 (FIG. 5) of the first standing step is set as 20 minutes as described above. By setting the period ti2 of the first standing step to be 20 minutes or longer, the electrode body 110 can uniformly absorb a sufficient amount of the first electrolytic solution 170.

Further, by setting the period ti2 of the first standing step to be 20 minutes or longer, the electrode body 110 and the first electrolytic solution 170 can contact each other for a sufficient period of time. As a result, a passive film can be sufficiently formed on the positive electrode non-contact portion PC of the electrode body 110. In the second embodiment, by sufficiently forming the passive film, the elution of aluminum from the positive electrode current collector foil P1 in the positive electrode non-contact portion PC, which is caused by the electrolytic solution 120 in which LiFSI as the second electrolyte 126 is dissolved after the second electrolytic solution accommodation step, can be reliably prevented. As a result, in the second embodiment, the deposition of aluminum and the deposition of lithium can be reliably prevented.

In the second embodiment, before the first standing step, the first pressure reduction step is performed in which the internal pressure of the battery case 130 is reduced to be lower than that of the first standing step. As a result, in the second embodiment, the period of time during which the electrode body 110 can absorb the first electrolytic solution 170 in the first standing step can be reduced. It is preferable that a difference between the internal pressure of the battery case 130 in the first pressure reduction step and the internal pressure of the battery case 130 in the first standing step is as large as possible. The reason for this is that, as the difference in the internal pressure between the first pressure reduction step and the first standing step increases, the period of time during which the electrode body 110 can absorb the first electrolytic solution 170 in the first standing step is likely to be reduced. Therefore, the first standing step may be performed after increasing the internal pressure of the battery case 130 to be higher than atmospheric pressure. In regard to this point, the same shall apply to the second pressure reduction step and the second standing step.

The present inventors verified the effects of the disclosure in a first experiment and a second experiment described below. In the first and second experiments, batteries of Examples 1 and 2 according to the second embodiment and batteries of Comparative Examples 1 to 3 for comparison with Examples 1 and 2 were prepared and used. Table 1 below shows respective manufacturing conditions of the batteries according to Examples 1 and 2 and the batteries according to Comparative Examples 1 to 3. Conditions other than the manufacturing conditions described below are the same as those of the above-described battery 100 in all of the batteries according to Example 1 and 2 and the batteries according to Comparative Examples 1 to 3.

TABLE 1

| | First Electrolytic Solution | | | Second Electrolytic Solution | | |
|---|---|---|---|---|---|---|
| | Accommodation Step | | | Accommodation Step | | |
| | Electrolyte | | Injection | Electrolyte | | Injection |
| | LiPF₆ | LiFSI | Amount | LiPF₆ | LiFSI | Amount |
| | (mol/kg) | (mol/kg) | (g) | (mol/kg) | (mol/kg) | (g) |
| Example 1 | 1.100 | 0 | 28 | 0 | 1.100 | 12 |
| Example 2 | 1.100 | 0 | 20 | 0 | 1.100 | 20 |
| Comparative | 1.100 | 0 | 40 | — | — | — |
| Example 1 | | | | | | |
| Comparative | 0.770 | 0.330 | 40 | — | — | — |
| Example 2 | | | | | | |
| Comparative | 0.550 | 0.550 | 40 | — | — | — |
| Example 3 | | | | | | |

The batteries according to Examples 1 and 2 were manufactured through the accommodation step shown in FIG. 4. That is, the batteries according to Examples 1 and 2 were manufactured by accommodating the electrolytic solution in the battery case through the two steps including the first electrolytic solution accommodation step and the second electrolytic solution accommodation step as shown in Table 1. In the batteries according to Examples 1 and 2, in the first electrolytic solution accommodation step, the first electrolytic solution in which LiPF₆ as the first electrolyte was dissolved in the nonaqueous solvent was accommodated in the battery case accommodating the electrode body. In the batteries according to Examples 1 and 2, in the second electrolytic solution accommodation step performed after the first standing step, the second electrolytic solution in which LiFSI as the second electrolyte was dissolved in the nonaqueous solvent was accommodated in the battery case. Therefore, in the electrolytic solutions of the batteries according to Examples 1 and 2, LiPF₆ and LiFSI were dissolved in the nonaqueous solvent.

In Examples 1 and 2, as the nonaqueous solvents of the first electrolytic solution and the second electrolytic solution, a mixed organic solvent in which EC, DMC, and EMC were mixed with each other at the following volume ratio was used.

EC:DMC:EMC=3:4:3

On the other hand, in Comparative Examples 1 to 3, the accommodation step was performed in a procedure different from that of Examples. Specifically, in the accommodation step of Comparative Examples 1 to 3, the steps shown in FIG. 4 after the second electrolytic solution accommodation step were not performed. That is, in Comparative Examples 1 to 3, the electrolytic solution was accommodated in the battery case in one go in the first electrolytic solution accommodation step. In Comparative Examples 1 to 3, as the nonaqueous solvent, a mixed organic solvent in which EC, DMC, and EMC were mixed with each other at the same volume ratio as that of Examples was used.

In Comparative Example 1, as shown in FIG. 1, an electrolytic solution in which only LiPF₆ was dissolved in the nonaqueous solvent was used as the first electrolytic solution in the first electrolytic solution accommodation step. Therefore, in the electrolytic solution of the manufactured battery according to the Comparative Example 1, only LiPF₆ was dissolved in the nonaqueous solvent.

In Comparative Examples 2 and 3, as shown in FIG. 1, an electrolytic solution in which LiPF₆ and LiFSI were dissolved in the nonaqueous solvent was used as the first electrolytic solution in the first electrolytic solution accommodation step. Therefore, in the electrolytic solutions of the batteries according to Comparative Examples 2 and 3, LiPF₆ and LiFSI were dissolved in the nonaqueous solvent. In the manufactured batteries according to Comparative Examples 2 and 3, the amount of the electrolytic solution and the molar concentrations of LiPF₆ and LiFSI in the electrolytic solution were the same as those of the manufactured batteries according to Examples 1 and 2.

In all of Examples 1 and 2 and Comparative Examples 1 to 3, the liquid injection hole was sealed with the liquid injection stopper after the accommodation step, and an initial charging step of initially charging the battery and an aging step of performing an aging treatment at a high temperature were performed. In all of Examples 1 and 2 and Comparative Examples 1 to 3, the initial charging step and the aging step were performed under the same conditions.

In the first experiment, internal resistance increase ratios of the batteries according to Examples 1 and 2 and Comparative Examples 1 to 3, which were manufactured as described above, were obtained and were compared to each other. Each of the internal resistance increase ratios was obtained by performing a cycle test on each of the batteries according to Examples 1 and 2 and Comparative Examples 1 to 3 and obtaining a ratio of an internal resistance value after the cycle test to an internal resistance value before the cycle test.

In the cycle test, charging and discharging were alternately repeated 2500 times in a temperature environment of 25° C. In the cycle test, charging was performed at a constant current value of 30 C for 10 seconds. The charging at 30 C in the cycle test is high-rate charging. In the cycle test, discharging was performed at a constant current value of 3 C for 100 seconds. An interval of 5 seconds during which charging and discharging were not performed was provided between charging and discharging in the cycle test.

Table 2 below shows the internal resistance increase ratio of each of the batteries according to Examples 1 and 2 and Comparative Examples 1 to 3 which was obtained in the first experiment.

TABLE 2

| | Internal Resistance |
|---|---|
| | Increase Ratio (%) |
| Example 1 | 116 |
| Example 2 | 111 |
| Comparative | 121 |
| Example 1 | |
| Comparative | 117 |
| Example 2 | |
| Comparative | 112 |
| Example 3 | |

As shown in Table 2, the internal resistance increase ratios of Examples 1 and 2 were lower than that of Comparative Example 1. The internal resistance increase ratios of Comparative Examples 2 and 3 were lower than that of Comparative Example 1. The reason for this is presumed to be that LiFSI was used as the electrolyte in Examples 1 and 2 and Comparative Examples 2 and 3.

The molar concentration of LiFSI in the electrolytic solution of the manufactured battery according to Example 1 was higher than that of Example 2. The internal resistance increase ratio of Example 2 was lower than that of Example 1. Further, the molar concentration of LiFSI in the electrolytic solution of the manufactured battery according to Comparative Example 3 was higher than that of Comparative Example 2. The internal resistance increase ratio of Comparative Example 3 was lower than that of Comparative Example 2.

That is, it was verified that, by using LiFSI as the electrolyte of the electrolytic solution, the ionic conductance of the electrolytic solution is improved, and an increase in the internal resistance of the battery can be reduced compared to a case where only LiPF₆ is used. It was also verified that, as the molar concentration of LiFSI in the electrolytic solution of the manufactured battery increases, the ionic conductance of the electrolytic solution is further improved, and an increase in the internal resistance of the battery can be further reduced.

In the second experiment, limit current values of the batteries according to Examples 1 and 2 and Comparative Examples 1 to 3, which were manufactured as described above, were obtained and were compared to each other. Each of the limit current values was obtained at a maximum C rate, where lithium was not deposited on the negative electrode sheet, by performing a cycle test, which was different from the cycle test relating to the internal resistance increase ratio, on each of the batteries according to Examples 1 and 2 and Comparative Examples 1 to 3 while slowly increasing a C rate relating to charging and discharging. Here, regarding “C rate”, 1 C represents a current value at which a battery can be charged to a full charge capacity after 1 hour or at which a battery having a full charge capacity can be completely discharged after 1 hour.

Specifically, in the cycle test relating to the limit current value, an operation of alternately repeating charging and discharging 1000 times at a constant C rate was set as one set, and this set was repeated multiple times in a temperature environment of −10° C. While alternately performing each of charging and discharging for 5 seconds in each set, an interval of 10 minutes during which charging and discharging were not performed was provided between charging and discharging. In a set of cycle test after the second set, the C rate relating to charging and discharging was increased to be higher than that of the previous set. After completion of each set of cycle test, the battery was disassembled to verify whether or not lithium was deposited on the negative electrode sheet. When the deposition of lithium on the negative electrode sheet of the battery was verified after completion of a set of cycle test, a current value of a C rate in the previous set of cycle test is set as a limit current value.

Table 3 below shows a limit current value ratio of each of the batteries according to Examples 1 and 2 and Comparative Examples 1 to 3 which was obtained in the second experiment. The limit current value ratio was obtained as a ratio of each of the obtained limit current values of Examples 1 and 2 and Comparative Examples 1 to 3 to the limit current value of Comparative Example 1.

TABLE 3

| | Limit Current |
|---|---|
| | Value Ratio (%) |
| Example 1 | 100 |
| Example 2 | 101 |
| Comparative | 100 |
| Example 1 | |
| Comparative | 96 |
| Example 2 | |
| Comparative | 94 |
| Example 3 | |

Here, in Comparative Example 1, as shown in Table 1, LiFSI was not used as the electrolyte of the electrolytic solution. Therefore, in Comparative Example 1, the elution of aluminum from the positive electrode current collector foil was not likely to occur, and the deposition of aluminum on the negative electrode sheet was not likely to occur. Therefore, the deposition of lithium on a portion where aluminum was deposited was not likely to occur.

As shown in Table 3, in Examples 1 and 2, each of the limit current values was equal to or higher than that of Comparative Example 1. The reason for this is presumed to be that, in Examples 1 and 2, the first electrolytic solution in which LiPF₆ was dissolved was accommodated in the battery case before accommodating the second electrolytic solution, in which LiFSI was dissolved, in the battery case. That is, the reason is presumed that, in Examples 1 and 2, a passive film was appropriately formed on a surface of the positive electrode current collector foil by the first electrolytic solution, in which LiPF₆ was dissolved, before accommodating the second electrolytic solution, in which LiFSI was dissolved, in the battery case. Accordingly, it is presumed that, even when the electrolytic solution in which LiFSI was dissolved contacted the positive electrode current collector foil on which the passive film was formed, the elution of aluminum from the positive electrode current collector foil was appropriately prevented. As a result, it is presumed that the deposition of aluminum and lithium on the negative electrode sheet was prevented.

On the other hand, the limit current values of Comparative Examples 2 and 3 were lower than those of Examples 1 and 2 and Comparative Example 1. The reason for this is presumed that, in Comparative Examples 2 and 3, the electrolytic solution in which LiPF₆ and LiFSI were dissolved was accommodated in the battery case. Therefore, it is presumed that aluminum was eluted from the positive electrode current collector foil, on which a passive film was not appropriately formed, in the electrolytic solution. It is presumed that the eluted aluminum was deposited on the negative electrode sheet, and lithium was deposited on the portion where aluminum was deposited.

Accordingly, it was verified from the first experiment and the second experiment that, in Examples 1 and 2 according to the second embodiment, the elution of aluminum from the positive electrode current collector foil, which may be caused by the electrolytic solution in which LiFSI was dissolved, was appropriately prevented. It was also verified that, in Examples 1 and 2 according to the second embodiment, the internal resistance increase ratios were low, and the limit current values was high. That is, it was verified that the durability of the battery according to the second embodiment is high.

### Third Embodiment

Next, a third embodiment will be described. In the third embodiment, a second electrolyte of an electrolytic solution is different from that of the first and second embodiments. The third embodiment is the same as the first and second embodiments, except that a different electrolyte is used as the second electrolyte.

Specifically, the second electrolyte 126 according to the third embodiment is lithium bis(trifluoromethanesulfonyl)imide (LiTFSI) represented by the formula LiN(SO₂CF₃)₂. The battery 100 according to the third embodiment is the same as that according to the first embodiment, except that the second electrolyte 126 is LiTFSi.

In the third embodiment, the battery 100 can be manufactured using the same method as in the first embodiment or the second embodiment. That is, the battery 100 is manufactured through the accommodation step which is performed in the procedure shown in FIG. 3 or 4, except that an electrolytic solution in which LiTFSI as the second electrolyte 126 is dissolved in the nonaqueous solvent 121 is used as the second electrolytic solution 180 in the second electrolytic solution accommodation step. LiTFSI as the second electrolyte 126 according to the third embodiment has a characteristic of causing aluminum, which constitutes the positive electrode current collector foil P1, to be eluted into the nonaqueous electrolytic solution 120 in a case where the second electrolytic solution 180 or the like in which LiTFSI is dissolved contacts the positive electrode current collector foil P1.

In the third embodiment, the electrode body accommodation step and the first electrolytic solution accommodation step are performed before the second electrolytic solution accommodation step. As a result, the positive electrode non-forming region PB as the positive electrode non-contact portion PC can be made to contact the first electrolytic solution 170 in which LiPF₆ as the first electrolyte 125 is dissolved. Therefore, in the third embodiment, a passive film can be formed on the positive electrode non-forming region PB as the positive electrode non-contact portion PC before the second electrolytic solution 180 or the electrolytic solution 120 in which LiTFSI as the second electrolyte 126 is dissolved contacts the positive electrode non-forming region PB.

Accordingly, in the third embodiment, aluminum constituting the positive electrode current collector foil P1 in the positive electrode non-contact portion PC is prevented from being eluted into the electrolytic solution 120. Accordingly, in the battery 100 according to the third embodiment, aluminum eluted from the positive electrode current collector foil P1 is prevented from being deposited on the negative electrode sheet N. However, in the third embodiment, the elution of aluminum in the positive electrode non-contact portion PC is prevented by the passive film. Thus, the deposition of a large amount of lithium on the negative electrode sheet N within a short period of time is prevented.

The battery 100 according to the third embodiment includes the electrolytic solution 120 in which LiTFSI as the second electrolyte 126 is dissolved. Thus, the ionic conductance is improved compared to a battery including an electrolytic solution in which only LiPF₆ as the first electrolyte 125 is dissolved. Accordingly, in the battery 100 according to the third embodiment, an increase in internal resistance caused when high-rate charging and discharging is repeated is reduced.

In the third embodiment, the accommodation step is performed in the same procedure as in the second embodiment. As a result, in the first standing step which is performed for 20 minutes or longer, the electrode body 110 can uniformly absorb a sufficient amount of the first electrolytic solution 170 before the second electrolytic solution accommodation step. In the first standing step which is performed for 20 minutes or longer, the electrode body 110 and the first electrolytic solution 170 can contact each other for a sufficient period of time. Therefore, a passive film can be sufficiently formed on the positive electrode non-contact portion PC.

Accordingly, in the third embodiment, by performing the accommodation step in the same procedure as in the second embodiment, the elution of aluminum from the positive electrode current collector foil P1 in the positive electrode non-contact portion PC, which is caused by the electrolytic solution 120 in which LiTFSI as the second electrolyte 126 is dissolved after the second electrolytic solution accommodation step, can be reliably prevented. As a result, the deposition of aluminum can be reliably prevented.

The present inventors verified the effects of the disclosure in a third experiment, a fourth experiment, and a fifth experiment described below. In the third, fourth, and fifth experiments, batteries of Examples 3 and 4 according to the third embodiment and batteries of Comparative Examples 1, 4, and 5 for comparison with Examples 3 and 4 were prepared and used. In order to manufacture the batteries according to Examples 3 and 4, the accommodation step was performed in the same procedure as in the second embodiment. Table 4 below shows respective manufacturing conditions of the batteries according to Examples 3 and 4 and the batteries according to Comparative Examples 4 and 5. Conditions other than the manufacturing conditions described below are the same as those of the above-described battery 100 in all of the batteries according to Example 3 and 4 and the batteries according to Comparative Examples 1, 4, and 5. The battery according to Comparative Example 1 was manufactured under the manufacturing conditions described above in Table 1.

TABLE 4

| | First Electrolytic Solution | | | Second Electrolytic Solution | | |
|---|---|---|---|---|---|---|
| | Accommodation Step | | | Accommodation Step | | |
| | Electrolyte | | Injection | Electrolyte | | Injection |
| | LiPF₆ | LiTFSI | Amount | LiPF₆ | LiTFSI | Amount |
| | (mol/kg) | (mol/kg) | (g) | (mol/kg) | (mol/kg) | (g) |
| Example 3 | 1.100 | 0 | 28 | 0 | 1.100 | 12 |
| Example 4 | 1.100 | 0 | 20 | 0 | 1.100 | 20 |
| Comparative | 0.770 | 0.330 | 40 | — | — | — |
| Example 4 | | | | | | |
| Comparative | 0.550 | 0.550 | 40 | — | — | — |
| Example 5 | | | | | | |

In Examples 3 and 4, as the nonaqueous solvents of the first electrolytic solution and the second electrolytic solution, a mixed organic solvent in which EC, DMC, and EMC were mixed with each other at the same volume ratio as that of Examples 1 and 2 was used. That is, the batteries according to Examples 3 and 4 were manufactured using the same method as in Examples 1 and 2, except that LiTFSI was used as the second electrolyte.

On the other hand, in Comparative Examples 4 and 5, the accommodation step was performed in a procedure different from that of Examples. Specifically, in the accommodation step of Comparative Examples 4 and 5, the steps shown in FIG. 4 after the second electrolytic solution accommodation step were not performed. That is, in Comparative Examples 4 and 5, the electrolytic solution was accommodated in the battery case in one go in the first electrolytic solution accommodation step. In Comparative Examples 4 and 5, as the nonaqueous solvent, a mixed organic solvent in which EC, DMC, and EMC were mixed with each other at the same volume ratio as that of Examples was used. That is, the batteries according to Comparative Examples 4 and 5 were manufactured using the same method as in Comparative Examples 2 and 3, except that LiTFSI was used as the second electrolyte.

In the third experiment, capacity retentions of the batteries according to Examples 3 and 4 and Comparative Examples 1, 4 and 5, which were manufactured as described above, were obtained and were compared to each other. Each of the capacity retentions was obtained by leaving each of the batteries according to Examples 3 and 4 and Comparative Examples 1, 4, and 5 to stand in an environment of 60° C. for a predetermined period of time in a high-temperature storage test and obtaining a ratio of a charge capacity of the battery after the high-temperature storage test to a charge capacity of the battery before the high-temperature storage test.

The charge capacities before and after the high-temperature storage test were calculated by charging and discharging the battery in an environment of 25° C. and adding up the amount of current during discharging. The charging before and after the high-temperature storage test relating to the calculation of the charge capacity was performed by constant current-constant voltage (CCCV) charging for 1 hour at an upper limit voltage of 4.1 V. The discharging before and after the high-temperature storage test relating to the calculation of the charge capacity was performed by CCCV discharging for 1 hour until the voltage reached 3.0 V.

Table 5 below shows the capacity retention of each of the batteries according to Examples 3 and 4 and Comparative Examples 1, 4, 5 which was obtained in the third experiment.

TABLE 5

| | Capacity |
|---|---|
| | Retention (%) |
| Example 3 | 85 |
| Example 4 | 89 |
| Comparative | 80 |
| Example 1 | |
| Comparative | 84 |
| Example 4 | |
| Comparative | 89 |
| Example 5 | |

As shown in Table 5, the capacity retentions of Examples 3 and 4 were higher than that of Comparative Example 1. The capacity retentions of Comparative Examples 4 and 5 were higher than that of Comparative Example 1. The capacity retention of Example 4 was lower than that of Example 3. The capacity retention of Comparative Example 5 was lower than that of Comparative Example 4.

That is, it was verified that, by using LiTFSI as the electrolyte of the electrolytic solution, a decrease in the charge capacity of the battery during high-temperature storage can be reduced compared to a case where only LiPF₆ is used. It was also verified that, as the molar concentration of LiTFSI in the electrolytic solution of the manufactured battery increases, a decrease in the charge capacity of the battery during high-temperature storage can be further reduced.

In the fourth experiment, internal resistance increase ratios of the batteries according to Examples 3 and 4 and Comparative Examples 1, 4, and 5, which were manufactured as described above, were obtained and were compared to each other. Each of the internal resistance increase ratios in the fourth experiment was obtained by leaving each of the batteries according to Examples 3 and 4 and Comparative Examples 1, 4, and 5 to stand in an environment of 60° C. for a predetermined period of time in a high-temperature storage test and obtaining a ratio of an internal resistance value of the battery after the high-temperature storage test to an internal resistance value of the battery before the high-temperature storage test.

The internal resistance values before and after the high-temperature storage test were calculated by charging the battery at a current value corresponding to a predetermined C rate for a predetermined period of time in an environment of 25° C. and obtaining a ratio of a voltage change during charging to an applied voltage during charging. The charging before and after the high-temperature storage test relating to the calculation of the internal resistance value was performed at a current value corresponding to a C rate of 30 C for 10 seconds after adjusting the voltage of the battery to 3.7 V.

Table 6 below shows the internal resistance increase ratio of each of the batteries according to Examples 3 and 4 and Comparative Examples 1, 4, and 5 which was obtained in the fourth experiment.

TABLE 6

| | Internal Resistance |
|---|---|
| | Increase Ratio (%) |
| Example 3 | 106 |
| Example 4 | 104 |
| Comparative | 111 |
| Example 1 | |
| Comparative | 107 |
| Example 4 | |
| Comparative | 104 |
| Example 5 | |

As shown in Table 6, the internal resistance increase ratios of Examples 3 and 4 were lower than that of Comparative Example 1. The internal resistance increase ratios of Comparative Examples 4 and 5 were lower than that of Comparative Example 1. The internal resistance increase ratio of Example 4 was lower than that of Example 3. The internal resistance increase ratio of Comparative Example 5 was lower than that of Comparative Example 4.

That is, it was verified that, by using LiTFSI as the electrolyte of the electrolytic solution, the ionic conductance of the electrolytic solution is improved, and an increase in the internal resistance of the battery can be reduced compared to a case where only LiPF₆ is used. It was also verified that, as the molar concentration of LiTFSI in the electrolytic solution of the manufactured battery increases, the ionic conductance of the electrolytic solution is further improved, and an increase in the internal resistance of the battery can be further reduced.

In the fifth experiment, limit current values of the batteries according to Examples 3 and 4 and Comparative Examples 1, 4, and 5, which were manufactured as described above, were obtained and were compared to each other. Each of the limit current values of the batteries according to Examples 3 and 4 and Comparative Examples 1, 4, and 5 was obtained using the same method as that described in the second experiment.

Table 7 below shows a limit current value ratio which was obtained in each of the batteries according to Examples 3 and 4 and Comparative Examples 1, 4, and 5. The limit current value ratio was obtained as a ratio of each of the obtained limit current values of Examples 3 and 4 and Comparative Examples 1, 4, and 5 to the limit current value of Comparative Example 1.

TABLE 7

| | Limit Current |
|---|---|
| | Value Ratio (%) |
| Example 3 | 100 |
| Example 4 | 99 |
| Comparative | 100 |
| Example 1 | |
| Comparative | 95 |
| Example 4 | |
| Comparative | 96 |
| Example 5 | |

Here, in Comparative Example 1, LiTFSI was not used as the electrolyte of the electrolytic solution. Therefore, in Comparative Example 1, the elution of aluminum from the positive electrode current collector foil was not likely to occur, and the deposition of aluminum and lithium on the negative electrode sheet was not likely to occur.

As shown in Table 7, in Examples 3 and 4, each of the limit current values was equal to or slightly lower than that of Comparative Example 1. The reason for this is presumed to be that, in Examples 3 and 4, the first electrolytic solution in which LiPF₆ was dissolved was accommodated in the battery case before accommodating the second electrolytic solution, in which LiTFSI was dissolved, in the battery case. That is, the reason is presumed that, in Examples 3 and 4, a passive film was appropriately formed on a surface of the positive electrode current collector foil by the first electrolytic solution, in which LiPF₆ was dissolved, before accommodating the second electrolytic solution, in which LiTFSI was dissolved, in the battery case. Accordingly, it is presumed that, even when the electrolytic solution in which LiTFSI was dissolved contacted the positive electrode current collector foil on which the passive film was formed, the elution of aluminum from the positive electrode current collector foil was appropriately prevented. As a result, it is presumed that the deposition of aluminum and lithium on the negative electrode sheet was prevented.

On the other hand, the limit current values of Comparative Examples 4 and 5 were lower than those of Examples 3 and 4 and Comparative Example 1. The reason for this is presumed that, in Comparative Examples 4 and 5, the electrolytic solution in which LiPF₆ and LiTFSI were dissolved was accommodated in the battery case. Therefore, it is presumed that aluminum was eluted from the positive electrode current collector foil, on which a passive film was not appropriately formed, in the electrolytic solution. It is presumed that the eluted aluminum was deposited on the negative electrode sheet, and lithium was deposited on the portion where aluminum was deposited.

Accordingly, it was verified from the fifth experiment that, in Examples 3 and 4 according to the third embodiment, the elution of aluminum from the positive electrode current collector foil, which may be caused by the electrolytic solution in which LiTFSI was dissolved, was appropriately prevented. It was also verified that, in Examples 3 and 4 according to the third embodiment, the internal resistance increase ratios were low, and the capacity retentions and the limit current values were high. That is, it was verified that the durability of the battery according to the third embodiment is high.

### Fourth Embodiment

Next, a fourth embodiment will be described. In the fourth embodiment, as the second electrolyte of the electrolytic solution, an electrolyte different from that of the first and second embodiments was used. The fourth embodiment is the same as the first and second embodiments, except that a different electrolyte is used as the second electrolyte.

Specifically, the second electrolyte 126 according to the fourth embodiment is lithium trifluoromethanesulfonate (LiTFS) represented by the formula LiCF₃SO₃. The battery 100 according to the fourth embodiment is the same as that according to the first embodiment, except that the second electrolyte 126 is LiTFS.

In the fourth embodiment, the battery 100 can be manufactured using the same method as in the first embodiment or the second embodiment. That is, the battery 100 is manufactured through the accommodation step which is performed in the procedure shown in FIG. 3 or 4, except that an electrolytic solution in which LiTFS as the second electrolyte 126 is dissolved in the nonaqueous solvent 121 is used as the second electrolytic solution 180 in the second electrolytic solution accommodation step. LiTFS as the second electrolyte 126 according to the fourth embodiment has a characteristic of causing aluminum, which constitutes the positive electrode current collector foil P1, to be eluted into the nonaqueous electrolytic solution 120 in a case where the second electrolytic solution 180 or the like in which LiTFS is dissolved contacts the positive electrode current collector foil P1.

In the fourth embodiment, the electrode body accommodation step and the first electrolytic solution accommodation step are performed before the second electrolytic solution accommodation step. As a result, the positive electrode non-forming region PB as the positive electrode non-contact portion PC can be made to contact the first electrolytic solution 170 in which LiPF₆ as the first electrolyte 125 is dissolved. Therefore, in the fourth embodiment, a passive film can be formed on the positive electrode non-forming region PB as the positive electrode non-contact portion PC before the second electrolytic solution 180 or the electrolytic solution 120 in which LiTFS as the second electrolyte 126 is dissolved contacts the positive electrode non-forming region PB.

Accordingly, in the fourth embodiment, aluminum constituting the positive electrode current collector foil P1 in the positive electrode non-contact portion PC is prevented from being eluted into the electrolytic solution 120. Accordingly, in the battery 100 according to the fourth embodiment, aluminum eluted from the positive electrode current collector foil P1 is prevented from being deposited on the negative electrode sheet N. However, in the fourth embodiment, the elution of aluminum in the positive electrode non-contact portion PC is prevented by the passive film. Thus, the deposition of a large amount of lithium on the negative electrode sheet N within a short period of time is prevented.

The battery 100 according to the fourth embodiment includes the electrolytic solution 120 in which LiTFS as the second electrolyte 126 is dissolved. Thus, the ionic conductance is improved compared to a battery including an electrolytic solution in which only LiPF₆ as the first electrolyte 125 is dissolved. Accordingly, in the battery 100 according to the fourth embodiment, an increase in internal resistance caused when high-rate charging and discharging is repeated is reduced.

In the fourth embodiment, the accommodation step is performed in the same procedure as in the second embodiment. As a result, in the first standing step which is performed for 20 minutes or longer, the electrode body 110 can uniformly absorb a sufficient amount of the first electrolytic solution 170 before the second electrolytic solution accommodation step. In the first standing step which is performed for 20 minutes or longer, the electrode body 110 and the first electrolytic solution 170 can contact each other for a sufficient period of time. Therefore, a passive film can be sufficiently formed on the positive electrode non-contact portion PC.

Accordingly, in the fourth embodiment, by performing the accommodation step in the same procedure as in the second embodiment, the elution of aluminum from the positive electrode current collector foil P1 in the positive electrode non-contact portion PC, which is caused by the electrolytic solution 120 in which LiTFS as the second electrolyte 126 is dissolved after the second electrolytic solution accommodation step, can be reliably prevented. As a result, the deposition of aluminum can be reliably prevented.

The present inventors verified the effects of the disclosure in a sixth experiment, a seventh experiment, and an eighth experiment described below. In the sixth, seventh, and eighth experiments, batteries of Examples 5 and 6 according to the fourth embodiment and batteries of Comparative Examples 1, 6, and 7 for comparison with Examples 5 and 6 were prepared and used. In order to manufacture the batteries according to Examples 5 and 6, the accommodation step was performed in the same procedure as in the second embodiment. Table 8 below shows respective manufacturing conditions of the batteries according to Examples 5 and 6 and the batteries according to Comparative Examples 6 and 7. Conditions other than the manufacturing conditions described below are the same as those of the above-described battery 100 in all of the batteries according to Example 5 and 6 and the batteries according to Comparative Examples 1, 6, and 7. The battery according to Comparative Example 1 was manufactured under the manufacturing conditions described above in Table 1.

TABLE 8

| | First Electrolytic Solution | | | Second Electrolytic Solution | | |
|---|---|---|---|---|---|---|
| | Accommodation Step | | | Accommodation Step | | |
| | Electrolyte | | Injection | Electrolyte | | Injection |
| | LiPF₆ | LiTFS | Amount | LiPF₆ | LiTFS | Amount |
| | (mol/kg) | (mol/kg) | (g) | (mol/kg) | (mol/kg) | (g) |
| Example 5 | 1.100 | 0 | 28 | 0 | 1.100 | 12 |
| Example 6 | 1.100 | 0 | 20 | 0 | 1.100 | 20 |
| Comparative | 0.770 | 0.330 | 40 | — | — | — |
| Example 6 | | | | | | |
| Comparative | 0.550 | 0.550 | 40 | — | — | — |
| Example 7 | | | | | | |

In Examples 5 and 6, as the nonaqueous solvents of the first electrolytic solution and the second electrolytic solution, a mixed organic solvent in which EC, DMC, and EMC were mixed with each other at the same volume ratio as that of Examples 1 and 2 was used. That is, the batteries according to Examples 5 and 6 were manufactured using the same method as in Examples 1 and 2, except that LiTFS was used as the second electrolyte.

On the other hand, in Comparative Examples 6 and 7, the accommodation step was performed in a procedure different from that of Examples. Specifically, in the accommodation step of Comparative Examples 6 and 7, the steps shown in FIG. 4 after the second electrolytic solution accommodation step were not performed. That is, in Comparative Examples 6 and 7, the electrolytic solution was accommodated in the battery case in one go in the first electrolytic solution accommodation step. In Comparative Examples 6 and 7, as the nonaqueous solvent, a mixed organic solvent in which EC, DMC, and EMC were mixed with each other at the same volume ratio as that of Examples was used. That is, the batteries according to Comparative Examples 6 and 7 were manufactured using the same method as in Comparative Examples 2 and 3, except that LiTFS was used as the second electrolyte.

In the sixth experiment, capacity retentions of the batteries according to Examples 5 and 6 and Comparative Examples 1, 6 and 7, which were manufactured as described above, were obtained and were compared to each other. In the sixth experiment, each of the capacity retentions was obtained using the same method as in the third experiment.

Table 9 below shows the capacity retention of each of the batteries according to Examples 5 and 6 and Comparative Examples 1, 6, 7 which was obtained in the sixth experiment.

TABLE 9

| | Capacity |
|---|---|
| | Retention (%) |
| Example 5 | 86 |
| Example 6 | 92 |
| Comparative | 80 |
| Example 1 | |
| Comparative | 85 |
| Example 6 | |
| Comparative | 91 |
| Example 7 | |

As shown in Table 9, the capacity retentions of Examples 5 and 6 were higher than that of Comparative Example 1. The capacity retentions of Comparative Examples 6 and 7 were higher than that of Comparative Example 1. The capacity retention of Example 6 was lower than that of Example 5. The capacity retention of Comparative Example 7 was lower than that of Comparative Example 6.

That is, it was verified that, by using LiTFS as the electrolyte of the electrolytic solution, a decrease in the charge capacity of the battery during high-temperature storage can be reduced compared to a case where only LiPF₆ is used. It was also verified that, as the molar concentration of LiTFS in the electrolytic solution of the manufactured battery increases, a decrease in the charge capacity of the battery during high-temperature storage can be further reduced.

In the seventh experiment, internal resistance increase ratios of the batteries according to Examples 5 and 6 and Comparative Examples 1, 6, and 7, which were manufactured as described above, were obtained and were compared to each other. In the seventh experiment, each of the internal resistance increase ratios was obtained using the same method as in the fourth experiment.

Table 10 below shows the internal resistance increase ratio of each of the batteries according to Examples 5 and 6 and Comparative Examples 1, 6, and 7 which was obtained in the seventh experiment.

TABLE 10

| | Internal Resistance |
|---|---|
| | Increase Ratio (%) |
| Example 5 | 104 |
| Example 6 | 102 |
| Comparative | 111 |
| Example 1 | |
| Comparative | 105 |
| Example 6 | |
| Comparative | 103 |
| Example 7 | |

As shown in Table 10, the internal resistance increase ratios of Examples 5 and 6 were lower than that of Comparative Example 1. The internal resistance increase ratios of Comparative Examples 6 and 7 were lower than that of Comparative Example 1. The internal resistance increase ratio of Example 5 was lower than that of Example 6. The internal resistance increase ratio of Comparative Example 7 was lower than that of Comparative Example 6.

That is, it was verified that, by using LiTFS as the electrolyte of the electrolytic solution, the ionic conductance of the electrolytic solution is improved, and an increase in the internal resistance of the battery can be reduced compared to a case where only LiPF₆ is used. It was also verified that, as the molar concentration of LiTFS in the electrolytic solution of the manufactured battery increases, the ionic conductance of the electrolytic solution is further improved, and an increase in the internal resistance of the battery can be further reduced.

In the eighth experiment, limit current values of the batteries according to Examples 5 and 6 and Comparative Examples 1, 6, and 7, which were manufactured as described above, were obtained and were compared to each other. Each of the limit current values of the batteries according to Examples 5 and 6 and Comparative Examples 1, 6, and 7 was obtained using the same method as that described in the second experiment.

Table 11 below shows a limit current value ratio which was obtained in each of the batteries according to Examples 5 and 6 and Comparative Examples 1, 6, and 7. The limit current value ratio was obtained as a ratio of each of the obtained limit current values of Examples 5 and 6 and Comparative Examples 1, 6, and 7 to the limit current value of Comparative Example 1.

TABLE 11

| | Limit Current |
|---|---|
| | Value Ratio (%) |
| Example 5 | 99 |
| Example 6 | 100 |
| Comparative | 100 |
| Example 1 | |
| Comparative | 94 |
| Example 6 | |
| Comparative | 93 |
| Example 7 | |

Here, in Comparative Example 1, LiTFS was not used as the electrolyte of the electrolytic solution. Therefore, in Comparative Example 1, the elution of aluminum from the positive electrode current collector foil was not likely to occur, and the deposition of aluminum and lithium on the negative electrode sheet was not likely to occur.

As shown in Table 11, in Examples 5 and 6, each of the limit current values was equal to or slightly lower than that of Comparative Example 1. The reason for this is presumed to be that, in Examples 5 and 6, the first electrolytic solution in which LiPF₆ was dissolved was accommodated in the battery case before accommodating the second electrolytic solution, in which LiTFS was dissolved, in the battery case. That is, the reason is presumed that, in Examples 5 and 6, a passive film was appropriately formed on a surface of the positive electrode current collector foil by the first electrolytic solution, in which LiPF₆ was dissolved, before accommodating the second electrolytic solution, in which LiTFS was dissolved, in the battery case. Accordingly, it is presumed that, even when the electrolytic solution in which LiTFS was dissolved contacted the positive electrode current collector foil on which the passive film was formed, the elution of aluminum from the positive electrode current collector foil was appropriately prevented. As a result, it is presumed that the deposition of aluminum and lithium on the negative electrode sheet was prevented.

On the other hand, the limit current values of Comparative Examples 6 and 7 were lower than those of Examples 5 and 6 and Comparative Example 1. The reason for this is presumed that, in Comparative Examples 6 and 7, the electrolytic solution in which LiPF₆ and LiTFS were dissolved was accommodated in the battery case. Therefore, it is presumed that aluminum was eluted from the positive electrode current collector foil, on which a passive film was not appropriately formed, in the electrolytic solution. It is presumed that the eluted aluminum was deposited on the negative electrode sheet, and lithium was deposited on the portion where aluminum was deposited.

Accordingly, it was verified from the eighth experiment that, in Examples 5 and 6 according to the fourth embodiment, the elution of aluminum from the positive electrode current collector foil, which may be caused by the electrolytic solution in which LiTFS was dissolved, was appropriately prevented. It was also verified that, in Examples 5 and 6 according to the fourth embodiment, the internal resistance increase ratios were low, and the capacity retentions and the limit current values were high. That is, it was verified that the durability of the battery according to the fourth embodiment is high.

As described above in detail, the method of manufacturing the battery 100 according to any one of the above-described embodiments includes the accommodation step of accommodating the electrode body 110 and the electrolytic solution 120 in the battery case 130. The accommodation step includes the electrode body accommodation step, the first electrolytic solution accommodation step, and the second electrolytic solution accommodation step. In the electrode body accommodation step, the electrode body 110 is accommodated in the battery case 130. In the first electrolytic solution accommodation step, the first electrolytic solution 170 is accommodated in the battery case 130. In the second electrolytic solution accommodation step, the second electrolytic solution 180 is accommodated in the battery case 130 accommodating the electrode body 110 and the first electrolytic solution 170. As the positive electrode current collector foil P1 of the positive electrode sheet P, an aluminum foil is used. In the first electrolytic solution 170, LiPF₆ as the first electrolyte 125 is dissolved in the nonaqueous solvent 121 without LiFSI, LiTFSI, or LiTFS as the second electrolyte 126 being dissolved. Further, in the second electrolytic solution 180, at least one selected from the group consisting of LiFSI, LiTFSI, and LiTFS which are the second electrolytes 126 is dissolved in the nonaqueous solvent 121. As a result, a method of manufacturing a nonaqueous electrolyte secondary battery can be realized in which elution of aluminum from a positive electrode current collector foil can be prevented.

The embodiment is not intended to be limiting, and various modifications can be made to it. For example, the shape of the wound electrode body 110 is not limited to a flat shape, but a wound electrode body having a cylindrical shape can also be used. In addition, for example, the embodiment can be applied not only a wound electrode body but also a laminate electrode body. For example, the above-described materials such as the positive electrode active material are merely exemplary, and the embodiment is not limited thereto.

For example, in the accommodation step, unlike the procedure shown in FIG. 3 or 4, the order of the electrode body accommodation step and the first electrolytic solution accommodation step may be reversed. For example, in the accommodation step, the electrode body accommodation step and the first electrolytic solution accommodation step may be performed at the same time. That is, it is only necessary that the second electrolytic solution accommodation step is performed after the electrode body accommodation step and the first electrolytic solution accommodation step. Even in this case, there is no change in that a passive film can be formed on a surface of the positive electrode current collector foil P1 in the positive electrode non-forming region PB before the second electrolytic solution accommodation step.

For example, in each of the above-described embodiments, only one of LiFSI, LiTFSI, or LiTFS is used as the second electrolyte 126. However, a mixture of plural kinds among LiFSI, LiTFSI, and LiTFS may be used as the second electrolyte 126. In the second electrolytic solution 180, for example, not only the second electrolyte 126 (at least one selected from the group consisting of LiFSI, LiTFSI, and LiTFS) but also another electrolyte may be dissolved. Specifically, in the second electrolytic solution 180, for example, LiPF6 as the first electrolyte 125 and LiFSI as the second electrolyte 126 may be dissolved. For example, different nonaqueous solvents may be used in the first electrolytic solution 170 and the second electrolytic solution 180.

In the above description of the embodiments, the positive electrode non-contact portion PC is the positive electrode non-forming region PB. However, actually, the positive electrode active material layer P2 is not densely formed without gaps, and is a porous body in which fine plural pores are present. Therefore, the positive electrode non-contact portion PC, in which the positive electrode active material layer P2 does not contact the surface of the positive electrode current collector foil P1, may be present in the positive electrode-forming region PA as indicated by the parenthesis of FIG. 2. That is, the positive electrode non-contact portion PC may be present in a positive electrode sheet not including the positive electrode non-forming region PB. That is, the embodiment is applicable to a positive electrode sheet not including the positive electrode non-forming region PB as long as the positive electrode non-contact portion PC is present in the positive electrode-forming region PA.

What is claimed is:

1. A method of manufacturing a nonaqueous electrolyte secondary battery,
the nonaqueous electrolyte secondary battery including a positive electrode sheet, a negative electrode sheet, a nonaqueous electrolytic solution that is obtained by dissolving an electrolyte in a nonaqueous solvent, and a battery case that accommodates the positive electrode sheet, the negative electrode sheet, and the nonaqueous electrolytic solution,
the positive electrode sheet including a positive electrode current collector foil and a positive electrode active material layer that is formed on the positive electrode current collector foil,
the positive electrode current collector foil having a surface on which a positive electrode non-contact portion which does not contact the positive electrode active material layer is formed, and
the method comprising:
accommodating an electrode body including the positive electrode sheet and the negative electrode sheet in the battery case, the positive electrode sheet having a configuration in which the positive electrode current collector foil is made of aluminum;
accommodating a first nonaqueous electrolytic solution in the battery case, the first nonaqueous electrolytic solution having a configuration in which lithium hexafluorophosphate is dissolved as the electrolyte in the nonaqueous solvent without lithium bis(fluorosulfonyl)imide, lithium bis(trifluoromethanesulfonyl)imide, and lithium trifluoromethanesulfonate being dissolved; and
accommodating a second nonaqueous electrolytic solution in the battery case that accommodates the electrode body and the first nonaqueous electrolytic solution, the second nonaqueous electrolytic solution having a configuration in which at least one selected from the group consisting of lithium bis(fluorosulfonyl)imide, lithium bis(trifluoromethanesulfonyl)imide, and lithium trifluoromethanesulfonate is dissolved as the electrolyte in the nonaqueous solvent.

2. The method according to claim 1, wherein
the second nonaqueous electrolytic solution is accommodated in the battery case 20 minutes or longer after accommodating the electrode body and the first nonaqueous electrolytic solution in the battery case.

3. The method according to claim 1, further comprising:
reducing an internal pressure of the battery case to be lower than atmospheric pressure after accommodating the electrode body and the first nonaqueous electrolytic solution in the battery case; and
increasing the reduced internal pressure of the battery case before accommodating the second nonaqueous electrolytic solution in the battery case.

4. The method according to claim 3, wherein
the second nonaqueous electrolytic solution is accommodated in the battery case 20 minutes or longer after accommodating the electrode body and the first nonaqueous electrolytic solution in the battery case

5. The method according to claim 1, further comprising:
reducing an internal pressure of the battery case to be lower than atmospheric pressure after accommodating the second nonaqueous electrolytic solution in the battery case; and
increasing the reduced internal pressure of the battery case.
